(19) United States
(12) Patent Application Publication
(10) Pub. No.: US 2014/0362038 A1
(43) Pub. Date: Dec. 11, 2014

(54) TOUCH PAD WITH ANTENNA

(71) Applicant: ALPS ELECTRIC CO., LTD., Tokyo (JP)

(72) Inventors: Takahiro MURAKAMI, Miyagi-ken (JP); Sadakazu SHIGA, Miyagi-ken (JP); Takeshi MASAKI, Miyagi-ken (JP); Hiroaki TAKAHASHI, Miyagi-ken (JP)

(73) Assignee: ALPS ELECTRIC CO., LTD., Tokyo (JP)

(21) Appl. No.: 14/250,221

(22) Filed: Apr. 10, 2014

(30) Foreign Application Priority Data
Jun. 10, 2013 (JP) 2013-121837

(51) Int. Cl. G06F 3/041; G06F 3/044

(52) U.S. Cl. CPC G06F 3/0416; G06F 3/044
USPC 345/174

(57) ABSTRACT

A touch pad with an antenna includes an electrode, control means for detecting proximity and a proximate position of an object on the basis of a change in capacitance which is associated with the proximity of the object to the electrode, an antenna, and antenna driving means for supplying power to the antenna. When the proximity of the object is not detected, the control means controls driving of the antenna driving means to set an output of the antenna to an output during ordinary driving. When the proximity of the object is detected, the control means controls driving of the antenna driving means to attenuate the output of the antenna with respect to the output during ordinary driving or to set the output of the antenna to zero.

### CLAIM OF PRIORITY

This application claims benefit of Japanese Patent Application No. 2013-121837 filed on Jun. 10, 2013, which is hereby incorporated by reference.

### BACKGROUND OF THE INVENTION

1. Field of the Invention

The present invention relates to a touch pad with an antenna which is mounted on a personal computer and the like to be capable of detecting a position of a finger and performing communication with another electronic device such as a smartphone.

2. Description of the Related Art

In recent years, notebook PCs have been equipped with a function such as near field communication (NFC) to allow communication to be performed with a smartphone or the like. However, a housing is often formed of a metal in small and thin PCs, and thus radio waves are shielded, which makes it difficult to provide an antenna. Consequently, as in U.S. Pat. No. 6,380,930 below, it is suggested that an antenna be provided in a touch pad which is disposed in an open portion of a metal housing. Since radio waves are not shielded in the open portion in which the touch pad is disposed, it is possible to perform communication with the outside by providing the antenna.

The touch pad with an antenna disclosed in U.S. Pat. No. 6,380,930 is configured such that a touch sensor array and an antenna are mounted on a printed circuit board, and is disposed in the open portion of the housing. Accordingly, it is possible to perform communication with the outside without radio waves being shielded by the housing.

However, in a touch pad of a type detecting a finger on the basis of a change in capacitance, there is a problem in that position detection cannot be accurately performed due to a large influence of the driving of an antenna on the detection of capacitance.

### SUMMARY OF THE INVENTION

The present invention provides a touch pad with an antenna which is capable of reducing the influence of the driving of an antenna on the detection of capacitance and accurately performing position detection.

A touch pad with an antenna according to an aspect of the invention includes an electrode; control means for detecting proximity and a proximate position of an object on the basis of a change in capacitance which is associated with the proximity of the object to the electrode; an antenna; and antenna driving means for supplying power to the antenna. When the proximity of the object is not detected, the control means controls driving of the antenna driving means to set an output of the antenna to an output during ordinary driving. When the proximity of the object is detected, the control means controls driving of the antenna driving means to attenuate the output of the antenna with respect to the output during ordinary driving or to set the output of the antenna to zero.

Accordingly, it is possible to reduce the influence of the driving of the antenna on the detection of capacitance and to accurately perform position detection.

In the touch pad with an antenna according to the aspect of the invention, when the proximity of the object is detected, the control means may controls driving of the antenna driving means to attenuate the output of the antenna with respect to the output during ordinary driving so as not to set the output of the antenna to zero.

In a case where an output of the antenna is set to zero when the presence of an object is detected, when another electronic device, an IC card, or the like is held with a hand and is brought close to the touch pad, the proximity of a finger is detected or the other electronic device, the IC card, or the like is recognized as the proximity of an object, and thus there is a possibility of a communication-disabled state being always set. However, when an output of the antenna is attenuated with respect to an output during ordinary driving so as not to be set to zero, it is possible to start communication even though the proximity of a finger is detected or the other electronic device, the IC card, or the like is recognized as the proximity of an object.

In the touch pad with an antenna according to the aspect of the invention, the antenna driving means may be constituted by an AC power supply having one end connected to one end of the antenna and having the other end connected to the other end of the antenna, and may be constituted by an adjustment circuit connected to the antenna in parallel having switch means and a resistor which are connected to each other in series. The control means may close the switch means to attenuate the output of the antenna.

Accordingly, it is possible to attenuate an output of the antenna with a simple circuit configuration.

### BRIEF DESCRIPTION OF THE DRAWINGS

FIG. 1 is a diagram illustrating a touch pad with an antenna according to a first embodiment being applied to a notebook PC;

FIG. 2 is a top view of the touch pad with an antenna according to the first embodiment;

FIG. 3 is a system diagram of the touch pad with an antenna according to the first embodiment;

FIG. 4 is a diagram illustrating a circuit configuration of antenna driving means of the touch pad with an antenna according to the first embodiment; and

FIG. 5 is a flow chart illustrating an operation of control means of the touch pad with an antenna according to the first embodiment.

### DESCRIPTION OF THE PREFERRED EMBODIMENTS

Hereinafter, a touch pad 10 with an antenna according to a first embodiment will be described.

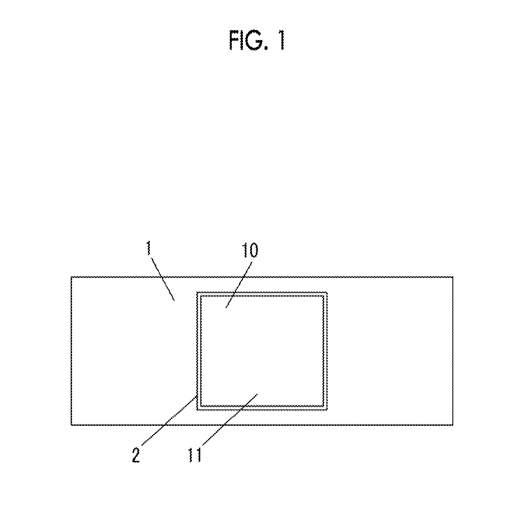

First, an arrangement state of the touch pad 10 with an antenna according to this embodiment will be described with reference to FIG. 1. FIG. 1 is a diagram schematically illustrating only a palm rest portion of a notebook PC excluding a display portion and a keyboard portion. An opening 2 is formed in a housing 1, and the touch pad 10 with an antenna is disposed in the opening 2. The housing 1 is formed of a metal such as stainless steel, and forms a coating on the surface of the housing. A face sheet 11 is attached to the surface of the touch pad 10 with an antenna, and an operator slides a finger on the face sheet 11. In addition, the touch pad 10 with an antenna is supported so as to be movable downward, and is configured to be capable of performing a push operation. Meanwhile, as a form different from this form, a form may be considered in which a cover made of resin which having no opening is attached onto a metallic housing having an opening and a touch pad with an antenna is attached from below to a position of the cover made of resin which corresponds to the open portion of the housing.

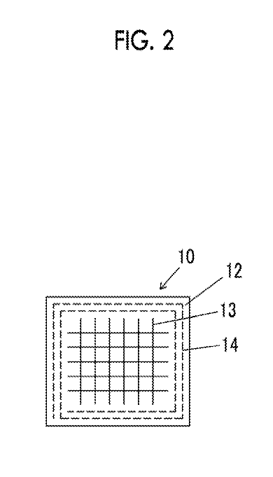

FIG. 2 is a top view of the touch pad 10 with an antenna in a state where the face sheet 11 is removed. The touch pad 10 with an antenna includes a substrate 12, and a plurality of electrodes 13 are laid on the surface side of the substrate 12. The plurality of electrodes 13 extend in a longitudinal direction and a transverse direction. One of an electrode group extending in the longitudinal direction and an electrode group extending in the transverse direction serves as a driving electrode, and the other serves as a detecting electrode.

An antenna 14 is laid on the surface side of the substrate 12. The antenna 14 is provided with antenna driving means 20 connected thereto so as to be capable of transmitting and receiving radio waves and communicating with an external device. Since the touch pad 10 with an antenna is not shielded by a metal, the touch pad can transmit radio waves.

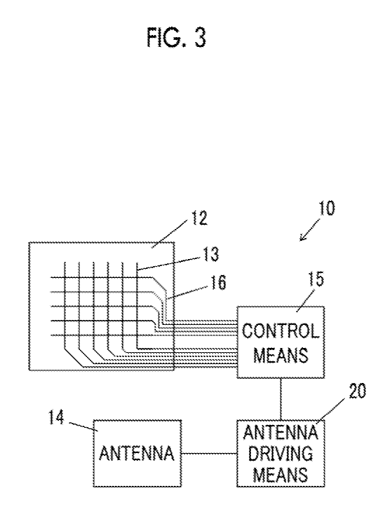

FIG. 3 is a system diagram of the touch pad 10 with an antenna according to this embodiment. The touch pad 10 with an antenna includes control means 15. The control means 15 and the electrodes 13 are connected to each other through wirings 16. The control means 15 performs driving control of the electrodes 13, detects a change in capacitance which is associated with the proximity of a finger, detects whether a finger approaches, and detects a proximate position of a finger. The wirings 16 are laid on the surface side of the substrate 12, and the control means 15 is also mounted on the surface side of the substrate 12. The antenna 14 is connected to the antenna driving means 20, and the antenna driving means 20 supplies power to the antenna 14. The antenna driving means 20 is connected to the control means 15, and is controlled by the control means 15.

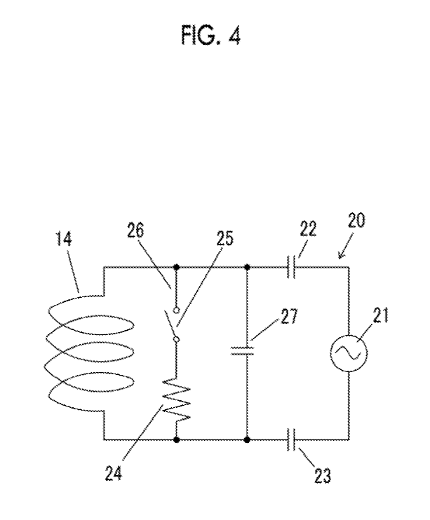

FIG. 4 is a diagram illustrating a circuit configuration of the antenna driving means 20 that drives the antenna 14 according to this embodiment. The antenna driving means 20 includes an AC power supply 21. The AC power supply 21 oscillates at 13.56 MHz, for example. One end and the other end of the antenna 14 are connected to one end and the other end of the AC power supply 21, respectively. An adjustment circuit 26 constituted by a resistor 24 and switch means 25, which are connected to each other in series, is connected to the antenna 14 in parallel. Capacitors 22, 23, and 27 are provided in order to match impedance in the respective lines. For example, a phototransistor or the like is considered as a specific example of the switch means 25.

During ordinary driving, the switch means 25 is opened, and thus an output of the AC power supply 21 is supplied to the antenna 14 without being consumed by the adjustment circuit 26. Accordingly, the antenna 14 is driven at high power. On the other hand, during attenuation driving, the switch means 25 is closed. Accordingly, an output of the AC power supply 21 is consumed by the adjustment circuit 26, and thus the antenna 14 is driven at low power.

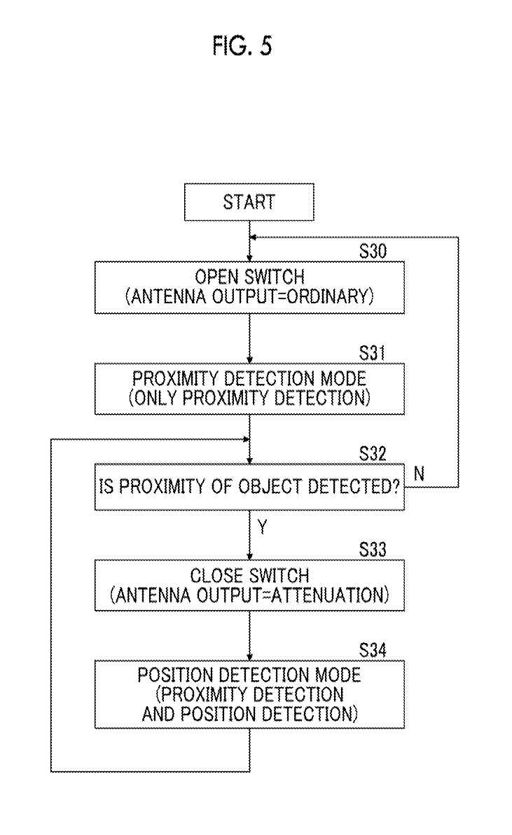

FIG. 5 is a flow chart illustrating an operation of the control means 15 of the touch pad 10 with an antenna according to this embodiment. First, in step S30, the switch means 25 is set to be in an open state, and ordinary driving of the antenna 14 is performed. Next, the operation proceeds to step S31 to set a proximity detection mode in which only proximity detection is performed and position detection is not performed. At this time, the antenna 14 is driven at high power, and thus position detection cannot be accurately performed in spite of an attempt thereof. However, even when there is interference with the antenna 14, it is possible to detect whether an object approaches or not. Next, the operation proceeds to step S32. When it is determined that the proximity of the object is detected, the operation proceeds to step S33 to set the switch means 25 to be in a closed state, and the attenuation driving of the antenna 14 is performed. After the switching to the attenuation driving, the operation proceeds to step S34 to perform switching to a position detection mode, and both proximity detection and position detection are performed. At this time, the antenna 14 is driven at low power and interference with the antenna 14 is low, and thus position detection can be accurately performed. Thereafter, the operation returns to step S32 to confirm as needed whether there is the proximity of an object. When it is determined in step S32 that the proximity of the object is not detected, the operation returns to step S30 to set the switch means 25 to be in an open state, and the ordinary driving of the antenna 14 is performed.

According to this embodiment, when the proximity of an object is detected, the control means 15 performs driving control of the antenna driving means 20 to attenuate an output of the antenna 14 with respect to an output during ordinary driving. Accordingly, interference with the antenna 14 has a negligible degree, and thus it is possible to reduce the influence of the driving of the antenna 14 on the detection of capacitance and to accurately perform position detection. Meanwhile, when the proximity of the object is not detected, the antenna 14 is driven at high power. However, at that time, position detection is not performed, and thus there is no problem. In addition, the level of accuracy of the proximity detection is slightly decreased in spite of interference with the antenna 14, and thus it is possible to perform the proximity detection without any difficulty.

In this embodiment, when it is determined that the proximity of the object is detected, the switch means 25 is set to be in a closed state so that the attenuation driving of the antenna 14 is performed and that an output of the antenna 14 is not set to be zero. In a case where an output of the antenna 14 is set to zero when the presence of an object is detected, when another electronic device, an IC card, or the like is held with a hand and is brought close to the touch pad 10, the proximity of a finger is detected or the other electronic device, the IC card, or the like is recognized as the proximity of an object, and thus there is a possibility of a communication-disabled state being always set. However, when an output of the antenna 14 is attenuated with respect to an output during ordinary driving so as not to be set to zero, it is possible to start communication even though the proximity of a finger is detected or the other electronic device, the IC card, or the like is recognized as the proximity of an object.

In this embodiment, a configuration has been employed in which the antenna driving means 20 includes the adjustment circuit 26 constituted by the resistor 24 and the switch means 25, which are connected to each other in series, and connected to the antenna 14 in parallel, and in which the control means 15 closes the switch means 25 to attenuate an output of the antenna 14. Although a configuration may also be considered in which switch means and a resistor are connected to each other in series, the same things are required to be connected to both ends of an antenna for impedance matching, and various restrictions are generated in the selection of the switch means. However, in the configuration as in this embodiment, it is possible to attenuate an output of the antenna 14 with a simple circuit configuration.

Meanwhile, in this embodiment, an output of the antenna 14 is attenuated with respect to an output during ordinary driving so as not to be set to zero. However, the present invention is not limited thereto, and the output of the antenna 14 may be set to zero. In addition, the adjustment circuit 26 constituted by the resistor 24 and the switch means 25, which are connected to each other in series, is connected to the antenna 14 in parallel. However, the present invention is not limited thereto, and any means may be connected to the antenna 14 in series.

It should be understood by those skilled in the art that various modifications, combinations, sub-combinations and alterations may occur depending on design requirements and other factors insofar as they are within the scope of the appended claims of the equivalents thereof.

1. A touch pad with an antenna, comprising:
an electrode;
a control unit configured to detect proximity of an object to the electrode and a position of the object based on a change in capacitance which is associated with the proximity of the object to the electrode;
an antenna; and
an antenna driving unit configured to supply power to the antenna,
wherein the control unit is further configured to control the antenna driving unit to:
drive the antenna at a first power level such that the antenna has a normal output when the proximity of the object is not detected; and
drive the antenna at a second power level lower than the first power level such that the antenna has to an attenuated output or zero output when the proximity of the object is detected.

2. The touch pad with an antenna according to claim 1, wherein the control unit controls the antenna driving unit such that the antenna has a non-zero attenuated output when the proximity of the object is detected.

3. The touch pad with an antenna according to claim 1,
wherein the antenna driving unit includes:
an AC power supply having one end connected to one end of the antenna and having the other end connected to the other end of the antenna; and
an adjustment circuit connected in parallel to the antenna, the adjustment circuit having a switch element and a resistor connected to the switch element in series, and
wherein the control means closes the switch element to attenuate the output of the antenna.

4. (canceled)

5. The touch pad with an antenna according to claim 1, wherein the control unit has a proximity detection mode in which only the proximity of the object is detected while the antenna has the normal output, and a position detection mode in which both of the proximity and the position of the object are detected while the antenna has the attenuated output.
